(19) United States
(12) Patent Application Publication
(10) Pub. No.: US 2025/0197651 A1
(43) Pub. Date: Jun. 19, 2025

(54) FLAME-RETARDANT COATINGS INCLUDING POLYELECTROLYTE

(71) Applicant: The Texas A&M University System, College Station, TX (US)

(72) Inventors: Jaime C. Grunlan, College Station, TX (US); Thomas J. Kolibaba, Westminster, CO (US)

(21) Appl. No.: 18/849,313

(22) PCT Filed: Mar. 22, 2023
(86) PCT No.: PCT/US2023/015907

§ 371 Date: Sep. 20, 2024

Related U.S. Application Data
(60) Provisional application No. 63/322,355, filed on Mar. 22, 2022.

(51) Int. Cl. C09D 5/18; C09D 4/06; C09D 133/14

(52) U.S. Cl. CPC C09D 5/18; C09D 4/06; C09D 133/14

(57) ABSTRACT

A flame-retardant treatment composition includes a polyamine, a phosphoric acid methacrylate ester, and a photoinitiator. A flame-retardant coating includes a photopolymerized product of the flame-retardant treatment composition. A flame-retardant substrate includes a porous substrate such as wood or a fiber and the flame-retardant coating thereon.

### CROSS-REFERENCE TO RELATED APPLICATION

This application claims the benefit of priority to U.S. Provisional Patent Application Ser. No. 63/322,355 filed Mar. 22, 2022, the disclosure of which is incorporated herein in its entirety by reference.

### BACKGROUND

Fires cause thousands of deaths, along with billions in property damage, annually in the United States. Home structure fires are responsible for about 75% of fire deaths and injuries in the United States, while also accounting for 40% of property damage. Wood is a very important building material for home structures, particularly because of its renewability, ease of processing, and excellent mechanical properties. Recently, additional concern has been raised because of the role outdoor wood structures (e.g., fences, sheds, etc.) play in spreading wildfires in wildland-urban interface communities. For these reasons, methods of effectively reducing wood flammability are of paramount importance.

Various chemistries have been developed in an effort to flame retard wood and wood-based materials. Halogenated flame retardants were the traditional approach, but have largely been phased out due to concerns regarding bioaccumulation and toxicity. Inorganic fillers such a metal hydroxides and metal hydroxy carbonates have also been implemented with some success, but their high loading requirements can detrimentally affect the mechanical properties of the substrate and make processing tedious.

Coating technologies have become an important and wide-ranging tool in fire protection over the past several years. In particular, polyelectrolyte coatings have risen to prominence owing to their ambient processing, wide variety of chemistries, and environmentally-benign nature. These coatings have primarily been deposited through layer-by-layer (LbL) assembly. This technology had become very important to the field of flame retardants, yielding effective treatments to improve the fire safety of household items like textiles and foams. However, despite more than a decade of enthusiastic research into this process, comparatively little work has been done with this technique to reduce the flammability of wood.

Wood is difficult to coat via the LbL deposition process because of its high surface area and very heterogeneous surface. These two factors lead to extremely long dip times being necessary to deposit effective coatings on wood. Dip-coating LbL is unrealistic for flame retarding wood, as these coatings typically require 10 or more bilayers to be effective, where each bilayer takes 1-4 hours to deposit due to the roughness of the wood surface. Spray-coating LbL has been explored as an alternative to dip-coating, eliminating the need for long dip times and rinsing steps. However, the substrate must be dried between each layer, requiring up to 2 hours per bilayer. Recently, alternatives to LbL assembly have been developed in which a polyelectrolyte complex (PEC) is deposited on a substrate in one or two steps (e.g., formed in-situ by treating a soluble complex with a buffer), dramatically reducing processing steps and time. These buffer-cured PEC treatments have also found use as gas barrier and antifouling coatings. However, the practical application of this technology for wood is still limited by the need for long, sequential immersions of the substrate and the fact that the buffers foul quickly and are not reusable.

### SUMMARY OF THE INVENTION

Various aspects of the present invention provide a flame-retardant treatment composition that includes a polyamine, a phosphoric acid methacrylate ester, and a photoinitiator.

Various aspects of the present invention provide a method of applying a flame-retardant treatment composition. The method includes applying a flame-retardant treatment composition to a substrate, wherein the flame-retardant treatment composition includes a polyamine, a phosphoric acid methacrylate ester, and a photoinitiator. The method also includes curing the composition on the substrate including exposing the composition on the substrate to light.

Various aspects of the present invention provide a flame-retardant coating that includes a photopolymerized product of a flame-retardant treatment composition that includes a polyamine, a phosphoric acid methacrylate ester, and a photoinitiator.

Various aspects of the present invention provide a flame-retardant coating that includes a polyelectrolyte complex of a polyamine and a poly(phosphoric acid methacrylate ester).

Various aspects of the present invention provide a flame-retardant substrate that includes a porous substrate and a flame-retardant coating thereon. The flame-retardant coating includes a photopolymerized product of a flame-retardant treatment composition that includes a polyamine, a phosphoric acid methacrylate ester, and a photoinitiator.

Various aspects of the present invention provide a flame-retardant substrate that includes a porous substrate and a flame-retardant coating thereon. The flame-retardant coating includes a polyelectrolyte complex of a polyamine and a poly(phosphoric acid methacrylate ester).

Various aspects of the present invention provide a flame-retardant substrate. The flame-retardant substrate includes a substrate that includes a fiber or wood. The flame-retardant substrate also includes a flame-retardant coating on the fiber or wood. The flame-retardant coating includes a polyelectrolyte complex of a polyamine and a poly(phosphoric acid methacrylate ester). A weight ratio of the polyamine to the poly(phosphoric acid methacrylate ester) is 1:1 to 1:10 and 1 wt % to 30 wt % of the flame-retardant substrate is the flame-retardant coating.

In various aspects, the flame-retardant treatment composition of the present invention and the flame-retardant coating formed therefrom provides an effective and efficient flame-retardant coating that can be deposited using fewer steps and/or in less time than other coatings. In various aspects, the flame-retardant treatment composition of the present invention and the flame-retardant coating formed therefrom can provide superior flame-retardant properties (e.g., reduction in total heat release, reducing in average heat release rate, reducing in maximum average rate of heat release, reduction in total smoke release, or a combination thereof) to a treated substrate, such as wood or a fiber, as compared to treated substrates formed from other flame-retardant treatment compositions. In various aspects, the flame-retardant treatment composition of the present invention and the flame-retardant coating formed therefrom can provide a higher weight gain to a substrate treated therewith, as compared to treated substrates formed from other flame-retardant treatment compositions. In various aspects, the flame-retardant treatment composition of the present invention and the flame-retardant coating formed therefrom can be more environmentally benign than other flame-retardant treatment compositions and flame-retardant coatings formed therefrom. In various aspects, the flame-retardant treatment composition of the present invention and the flame-retardant coating formed therefrom can impart greater mechanical strength to a substrate treated/coated therewith as compared to treated substrates formed form other flame-retardant treatment compositions. In various aspects, the flame-retardant treatment composition of the present invention and the method of using the same is compatible with current industrial wood treatment processes (e.g., pressure treatment) and fiber treatment processes and does not necessitate specialized equipment or facilities. In various aspects, the flame-retardant treatment composition of the present invention can be useful for imparting flame-retardant properties to a variety of porous substrates such as wood or fibers, and can be easily implemented in conventional textile finishing systems (e.g., pad-dry processing for dying of fabrics).

### BRIEF DESCRIPTION OF THE FIGURES

The drawings illustrate generally, by way of example, but not by way of limitation, various aspects of the present invention.

FIG. 1A illustrates a schematic of a coating process for wood, in accordance with various aspects

FIG. 1B illustrates a polycation (PEI) and an anionic monomer (HMP), in accordance with various aspects.

FIG. 1C illustrates a schematic showing formation of a photo-PEC from polymerization of HMP in the presence of UV light and a photoinitiator, in accordance with various aspects.

FIG. 2A illustrates GPC traces for polymerization products of various HMP-containing mixtures.

FIG. 2B illustrates inverted vials containing a (CH₃)₂NH:HMP solution at 0 min (before polymerization) and at 5 min (after polymerization), in accordance with various aspects.

FIG. 2C illustrates inverted vials containing a PEI:HMP solution at 0 min (before polymerization) and at 5 min (after polymerization), in accordance with various aspects.

FIG. 3A illustrates an EDS trace of coated wood reporting relative abundance of phosphorus at various depths, in accordance with various aspects.

FIG. 3B illustrates an EDS trace of coated wood reported relative abundance of nitrogen at various depths, with ovals indicating areas of low signal between plywood plies, in accordance with various aspects.

FIG. 4A illustrates a TGA plot of mass versus temperature for the outer ply of uncoated and photopolymerized wood coatings immersed for 1 and 60 minutes, in accordance with various aspects.

FIG. 4B illustrates a TGA plot of mass versus temperature for the inner ply of uncoated and photopolymerized wood coatings immersed for 1 and 60 minutes, in accordance with various aspects.

FIG. 5 illustrates a DMA plot of storage modulus versus temperature for coated and uncoated wood, in accordance with various aspects.

FIG. 6 illustrates a DMA plot of heat release rate versus time of uncoated and coated plywood, in accordance with various aspects.

FIG. 7A illustrates chemical structures of PEI, HMP, and TPO, in accordance with various aspects.

FIG. 7B illustrates a schematic illustrating a coating process for coating wood, in accordance with various aspects.

FIGS. 8A and 8D illustrate surface SEM images of uncoated natural wood, in accordance with various aspects.

FIGS. 8B and 8E illustrate surface SEM images of coated natural wood before flame testing, in accordance with various aspects.

FIGS. 8C and 8F illustrate surface SEM images of coated natural wood after flame testing, in accordance with various aspects.

FIGS. 9A and 9D illustrate surface SEM images of uncoated plywood, in accordance with various aspects.

FIGS. 9B and 9E illustrate surface SEM images of coated plywood before flame testing, in accordance with various aspects.

FIGS. 9C and 9F illustrate surface SEM images of coated plywood after flame testing.

FIG. 10A illustrates a schematic showing preparation of samples for EDS, in accordance with various aspects.

FIG. 10B illustrates EDS traces showing intensities of Kα peaks of nitrogen (bottom trace) and phosphorus (top trace) in cross-sectional areas of coated natural wood (top two plots) and coated plywood (bottom two plots), in accordance with various aspects.

FIG. 11A illustrates a thermogram plot of mass % versus temperature under air for coated and uncoated natural wood, in accordance with various aspects.

FIG. 11B illustrates a thermogram plot of mass loss rate versus temperature under air for coated and uncoated natural wood, in accordance with various aspects.

FIG. 11C illustrates a thermogram plot of mass % versus temperature under air for coated and uncoated plywood, in accordance with various aspects.

FIG. 11D illustrates a thermogram plot of mass loss rate versus temperature under air for coated and uncoated plywood, in accordance with various aspects.

FIG. 12A illustrates a thermogram plot of mass % versus temperature under nitrogen for coated and uncoated natural wood, in accordance with various aspects.

FIG. 12B illustrates a thermogram plot of mass loss rate versus temperature under nitrogen for coated and uncoated natural wood, in accordance with various aspects.

FIG. 12C illustrates a thermogram plot of mass % versus temperature under nitrogen for coated and uncoated plywood, in accordance with various aspects.

FIG. 12D illustrates a thermogram plot of mass loss rate versus temperature under nitrogen for coated and uncoated plywood, in accordance with various aspects.

FIG. 13A illustrates heat release rate versus time for coated and uncoated natural wood, in accordance with various aspects.

FIG. 13B illustrates heat release rate versus time for coated and uncoated plywood, in accordance with various aspects.

FIG. 14A illustrates three-point bending data as a plot of representative stress versus strain for natural wood, in accordance with various aspects.

FIG. 14B illustrates three-point bending data as a plot of representative stress versus strain for plywood, in accordance with various aspects.

FIG. 15 illustrates digital images of (a, c, e, g) uncoated and (b, d, f, h) coated (a-d) natural wood and (e-h) plywood (a, b, e, f) before and (c, d, g, h) after flame testing, in accordance with various aspects.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in a specific order as recited herein. Alternatively, in any aspect(s) disclosed herein, specific acts may be carried out in any order without departing from the principles of the invention, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

### Flame-Retardant Treatment Composition.

Various aspects of the present invention provide a flame-retardant treatment composition. The flame-retardant treatment composition includes a polyamine, a phosphoric acid methacrylate ester, and a photoinitiator. The flame-retardant treatment composition can be used to treat a substrate to form a flame-retardant substrate that has improved flame-retardant properties as compared to the corresponding untreated substrate (e.g., an otherwise identical substrate that has not been treated with the flame-retardant treatment composition).

The polyamine can form any suitable proportion of the flame-retardant treatment composition. For example, the polyamine can be 1 wt % to 25 wt % of the composition, or 5 wt % to 15 wt % of the composition, or less than 25 wt % and greater than 1 wt % and less than, equal to, or greater than 2 wt %, 3, 4, 5, 6, 7, 8, 9, 10, 11, 12, 13, 14, 15, 16, 17, 18, 19, 20, 21, 22, 23, or 24 wt %. For example, on a dry weight basis, the polyamine can be 10 wt % to 40 wt % of the composition, or 20 wt % to 30 wt %, or less than or equal to 40 wt % and greater than or equal to 10 wt % and less than, equal to, or greater than 12 wt %, 14, 16, 18, 20, 22, 24, 26, 28, 30, 32, 34, 36, or 38 wt %. The polyamine can have a weight-average molecular weight of 100 g/mol to 1,000,000 g/mol, or 100 g/mol to 5,000 g/mol, or less than or equal to 1,000,000 g/mol and greater than or equal to 100 g/mol and less than, equal to, or greater than 200 g/mol, 300, 400, 500, 600, 700, 800, 900, 1,000, 1,200, 1,400, 1,600, 1,800, 2,000, 2,500, 3,000, 4,000, 5,000, 6,000, 8,000, 10,000, 15,000, 20,000, 25,000, 30,000, 40,000, 50,000, 60,000, 80,000, 100,000, 150,000, 200,000, 250,000, 500,000, or 750,000 g/mol.

The polyamine can be any suitable one or more polyamines. The polyamine can include nitrogen atoms in the backbone of the polyamine. The polyamine can include polyethylenimine (PEI), poly(allylamine), poly(vinylamine), chitosan, a salt thereof (e.g., a hydrohalide salt), or a combination thereof. The polyamine can include polyethylenimine (PEI).

The phosphoric acid methacrylate ester can form any suitable proportion of the flame-retardant treatment composition. For example, the phosphoric acid methacrylate ester can be 5 wt % to 70 wt % of the composition, or 10 wt % to 50 wt % of the composition, or less than or equal to 70 wt % and greater than or equal to 5 wt % and less than, equal to, or greater than 10 wt %, 15, 20, 25, 30, 35, 40, 45, 50, 55, 60, or 65 wt %. For example, on a dry weight basis, the phosphoric acid methacrylate ester can be 50 wt % to 90 wt % of the composition, or 65 wt % to 80 wt %, or 70 wt % to 75 wt %, or less than or equal to 90 wt % and greater than or equal to 50 wt % and less than, equal to, or greater than 55 wt %, 60, 65, 70, 75, 80, or 85 wt %.

The phosphoric acid methacrylate ester can include any suitable one or more phosphoric acid methacrylate esters. The phosphoric acid methacrylate ester can be monofunctional (e.g., include one acrylate group per molecule) or multifunction (e.g., include more than one acrylate group per molecule) such as difunctional (i.e., include two acrylate groups per molecule). For example, the phosphoric acid methacrylate ester can include phosphoric acid 2-hydroxyethyl methacrylate ester (HMP), bis[2-(methacryloyloxy)ethyl]phosphate, or a combination thereof. The phosphoric acid methacrylate ester can be phosphoric acid 2-hydroxyethyl methacrylate ester (HMP). The flame-retardant treatment composition can have any suitable weight ratio of the polyamine to the phosphoric acid methacrylate ester, such as 1:1 to 1:10, 1:2 to 1:4, or greater than or equal to 1:10 and less than or equal to 1:1 and less than, equal to, or greater than 1:1.5, 1:2, 1:2.5, 1:3, 1:3.5, 1:4, 1:5, 1:6, 1:7, 1:8, or 1:9.

The photoinitiator can form any suitable proportion of the flame-retardant treatment composition. For example, on a dry weight basis, the photoinitiator can be 0.1 wt % to 10 wt % of the composition, or 1 wt % to 5 wt %, or less than or equal to 10 wt % and greater than or equal to 0.1 wt % and less than, equal to, or greater than 0.2 wt %, 0.4, 0.6, 0.8, 1, 2, 3, 4, 5, 6, 7, 8, or 9 wt %. For example, the photoinitiator can be 0.1 wt % to 5 wt % of the composition, or 0.5 wt % to 2 wt % of the composition, or less than or equal to 5 wt % and greater than or equal to 0.1 wt % and less than, equal to, or greater than 0.2, 0.3, 0.4, 0.5, 0.6, 0.7, 0.8, 0.9, 1, 1.2, 1.4, 1.6, 1.8, 2, 2.5, 3, 3.5, 4, or 4.5 wt %. The photoinitiator can include or be a photocatalyst. The photoinitiator can be a visible light photoinitiator, a UV photoinitiator, an IR photoinitiator, or a combination thereof. The photoinitiator can include any suitable photoinitiator, such as diphenyl(2,4,6 trimethylbenzoyl)phosphine oxide (TPO), phenylbis(2,4,6-trimethylbenzoyl)phosphine oxide, 2-hydroxy-2-methylpropiophenone, 2-hydroxy-4′-(2-hydroxyethoxy)-2-methylpropiophenone, lithium phenyl-2,4,6-trimethylbenzoylphosphinate (Li-TPO), ethyl phenyl(2,4,6-trimethylbenzoyl)phosphinate (TPO-L), camphorquinone, or a combination thereof. The photoinitiator can be diphenyl(2,4,6 trimethylbenzoyl)phosphine oxide (TPO).

The flame-retardant treatment composition can be substantially free of a solvent. In other aspects, the flame-retardant treatment composition can include a solvent. The solvent can be any suitable solvent, such as including an aqueous solvent, an organic solvent, or a combination thereof. The solvent can include water, an alcohol, or a combination thereof. The flame-retardant treatment composition including one or more solvents can have any suitable pH, such as a pH of 5 to 8, or 6 to 7, or less than or equal to 8 and greater than or equal to 5 and less than, equal to, or greater than 5.2, 5.4, 5.6, 5.8, 6, 6.2, 6.4, 6.6, 6.8, 7, 7.2, 7.4, 7.6, or 7.8.

### Method of Applying a Flame-Retardant Treatment Composition.

Various aspects of the present invention provide a method of applying a flame-retardant treatment composition. The method includes applying an embodiment of the flame-retardant treatment composition to a substrate. For example, the method includes applying a flame-retardant treatment composition to the substrate, the flame-retardant treatment composition including a polyamine, a phosphoric acid methacrylate ester, and a photoinitiator. The method also includes curing the composition on the substrate, wherein the curing includes exposing the composition on the substrate to light.

The method can further include drying the substrate including the cured composition. The drying can be any suitable drying, such as at 50° C. to 100° C., such as for a duration of 1 h to 48 h, such as at ambient pressure or under vacuum. The method can include rinsing the substrate in an aqueous solvent (e.g., water) after the applying and before the curing, after the curing and before any drying, or a combination thereof.

The applying the flame-retardant treatment composition to the substrate can be any suitable applying that includes contacting the flame-retardant treatment composition and the substrate. The applying can include immersing, spraying, brushing, or a combination thereof. The applying can include immersing the substrate in the flame-retardant treatment composition. The applying can include immersing the substrate in the flame-retardant treatment composition for a duration of 1 sec to 48 hours, or 1 min to 1 hour, or less than or equal to 48 hours and greater than or equal to 1 sec and less than, equal to, or greater than 2 sec, 5, 10, 15, 20, 30, 40, 50 sec, 1 min, 2, 5, 10, 15, 20, 30, 40, 50 min, 1 h, 2, 3, 4, 5, 6, 7, 8, 9, 10, 11, 12, 14, 16, 18, 20, 22, 24, 26, 28, 30, 32, 34, 36, 38, 40, 42, 44, or 46 h.

The light can include any suitable wavelength of light, such as visible, UV, IR, or a combination thereof. The light can include UV light. The UV light can include any suitable wavelength of light, such as a wavelength of 100 nm to 400 nm, or 360 nm to 370 nm, or less than or equal to 400 nm and greater than or equal to 100 nm and less than, equal to, or greater than 120, 140, 160, 180, 200, 220, 240, 260, 280, 300, 320, 340, 350, 352, 354, 356, 358, 360, 361, 362, 363, 364, 365, 366, 367, 368, 369, 370, 372, 374, 376, 378, 380, or 390 nm. The light treatment can include exposing the composition on the substrate to the light for a duration of 0.1 min to 1 hour, or 1 min to 20 min, or less than or equal to 1 h and greater than or equal to 0.1 min or less than, equal to, or greater than 0.2 min, 0.4, 0.6, 0.8, 1, 2, 3, 4, 5, 6, 7, 8, 9, 10, 11, 12, 13, 14, 15, 16, 17, 18, 19, 20, 25, 30, 35, 40, 45, 50, or 55 min. The exposing can include uniformly exposing the substrate to the the light, such as by flipping or turning the substrate in the light once or more than once during the exposing.

The substrate can be any suitable substrate. In various aspects, the substrate is a porous substrate including one or more surface pores therein. In various aspects, the applying of the flame-retardant treatment composition to the substrate can include permeating the flame-retardant treatment into pores (e.g., surface pores and/or internal pores fluidly connected to surface pores). In various aspects, the light treatment can include penetrating at least a portion of an interior of the substrate with the light to cure flame-retardant treatment composition within one or more pores of the substrate. The substrate can include a fabric (e.g., cotton). The substrate can include wood, such as any suitable type of wood, such as natural wood, plywood, or oriented strand board (OSB).

### Flame-Retardant Coating.

In various aspects, the present invention provides a flame-retardant coating. The flame-retardant coating can be on a substrate and can optionally also be in one or more pores of the substrate. The flame-retardant coating includes a photopolymerized product of an embodiment of the flame-retardant treatment composition described herein. For example, the flame-retardant coating includes a photopolymerized product (e.g., a UV-photopolymerized product) of a flame-retardant treatment composition that includes a polyamine, a phosphoric acid methacrylate ester, and a photoinitiator. The photopolymerized product of the flame-retardant treatment composition is a photopolymerized and dried product of the flame-retardant treatment composition.

The photopolymerized product of the flame-retardant treatment composition can include a polyelectrolyte complex of the polyamine and a polymer formed from the phosphoric acid methacrylate ester (i.e., a poly(phosphoric acid methacrylate ester)). In an aspect wherein the phosphoric acid methacrylate ester is HMP, the photopolymerized product of the flame-retardant treatment composition can include a poly(HMP):polyamine polyelectrolyte complex, or a poly(HMP):PEI polyelectrolyte complex.

Various aspects of the present invention provide a flame-retardant coating including a polyelectrolyte complex of the polyamine and a poly(phosphoric acid methacrylate ester). The polyelectrolyte complex can be a product of photopolymerization of a flame-retardant treatment composition including a polyamine, a phosphoric acid methacrylate ester, and a photoinitiator. The flame-retardant coating can have any suitable weight ratio of the polyamine to the poly(phosphoric acid methacrylate ester) corresponding to the weight ratios of polyamine and phosphoric acid methacrylate ester of embodiments of the flame-retardant treatment composition described herein, such as a weight ratio of the polyamine to the poly(phosphoric acid methacrylate ester) of 1:1 to 1:10, or 1:2 to 1:4, or greater than or equal to 1:10 and less than or equal to 1:1 and less than, equal to, or greater than 1:1.5, 1:2, 1:2.5, 1:3, 1:3.5, 1:4, 1:5, 1:6, 1:7, 1:8, or 1:9.

### Flame-Retardant Substrate.

Various aspects of the present invention provide a flame-retardant substrate. The flame-retardant substrate includes a porous substrate, and a flame-retardant coating on the porous substrate. The flame-retardant coating can be any suitable flame-retardant coating described herein, such as including a polyelectrolyte complex of a polyamine and a poly(phosphoric acid methacrylate ester), or such as including a photopolymerized product (e.g., a UV-photopolymerized product) of a flame-retardant treatment composition that includes a polyamine, a phosphoric acid methacrylate ester, and a photoinitiator.

Any suitable proportion of the flame-retardant substrate can be the flame-retardant coating (e.g., the substrate can experience any suitable weight gain as compared to the untreated substrate). For example, 0.1 wt % to 50 wt % of the flame-retardant substrate can be the flame-retardant coating, or 1 wt % to 30 wt %, or less than or equal to 50 wt % and greater than or equal to 0.1 wt % and less than, equal to, or greater than 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 32, 34, 36, 38, 40, 42, 44, 46, or 48 wt %.

The substrate can be any suitable porous substrate. The flame-retardant coating can be permeated into pores in the substrate (e.g., surface pores and/or internal pores fluidly connected to surface pores). The substrate can be wood, such as any suitable type of wood, such as natural wood, plywood, or oriented strand board (OSB). The flame-retardant coating can be penetrated into pores of the wood to any suitable depth consistent with the application and curing process, such as a depth of 1-20 mm, or 2-10 mm, or less than or equal to 20 mm and greater than or equal to 1 mm and less than, equal to, or greater than 2 mm, 3, 4, 5, 6, 7, 8, 9, 10, 11, 12, 13, 14, 15, 16, 17, 18, or 19 mm. In various aspects, the flame-retardant coating can be penetrated through an entire thickness of the wood.

Wood including the flame-retardant coating has improved flame-retardant properties relative to the same wood that is free of the flame-retardant coating. For example, as compared to a corresponding untreated substrate, the flame-retardant substrate has a reduction in afterburn time of 50% to 99.9% in a flame test including applying a flame 1 cm below the substrate for 10 s, removing the flame until flaming combustion stops, and then applying the flame 1 cm below the substrate for an additional 10 s, or 73% to 98%, or less than or equal to 99.9% and greater than or equal to 50% and less than, equal to, or greater than. For example, as compared to a corresponding untreated substrate, the flame-retardant substrate can have a decrease in maximum average rate of heat emission in cone calorimetry testing as per ASTM E-1354-22 of 10% to 60%, or 25% to 40%, or less than or equal to 60% and greater than or equal to 10% and less than, equal to, or greater than 15, 20, 22, 24, 25, 26, 27, 28, 29, 30, 31, 32, 33, 34, 35, 36, 37, 38, 39, 40, 42, 44, 46, 48, 50, 52, 54, 56, or 58%.

Various aspects of the present invention provide a flame-retardant substrate that includes a substrate including wood. The flame-retardant substrate also includes a flame-retardant coating on the wood, wherein the flame-retardant coating includes a polyelectrolyte complex of a polyamine and a poly(phosphoric acid methacrylate ester), wherein a weight ratio of the polyamine to the poly(phosphoric acid methacrylate ester) is 1:1 to 1:10 (e.g., 1:1 to 1:10, or 1:2 to 1:4, or greater than or equal to 1:10 and less than or equal to 1:1 and less than, equal to, or greater than 1:1.5, 1:2, 1:2.5, 1:3, 1:3.5, 1:4, 1:5, 1:6, 1:7, 1:8, or 1:9), and wherein 1 wt % to 30 wt % of the flame-retardant substrate is the flame-retardant coating (e.g., less than or equal to 30 wt % and greater than or equal to 1 wt % and less than, equal to, or greater than 2 wt %, 3, 4, 5, 6, 7, 8, 9, 10, 11, 12, 13, 14, 15, 16, 17, 18, 19, 20, 21, 22, 23, 24, 25, 26, 27, 28, or 29 wt %).

### EXAMPLES

Various aspects of the present invention can be better understood by reference to the following Examples which are offered by way of illustration. The present invention is not limited to the Examples given herein.

### Example 1

In this Example, a photopolymerized polyelectrolyte complex coating was demonstrated for the first time. This UV-curable coating comprised of polyethylenimine and a photopolymer of hydroxyethyl methacrylate phosphate is deposited in a single step. The coating was shown to be insoluble and ionically crosslinked as a result of the polymeric structure of PEI. The coating adds just 1.6 wt % to plywood and preserves its mechanical properties at high temperature. Furthermore, the coating reduces the peak heat release rate and significantly reduces its smoke release. This coating represents a much more scalable method to deposit functional polyelectrolyte coatings and could lead to more widespread adoption of polyelectrolyte complex treatments to enable safer wood construction.

Materials. Polyethylenimine (PEI, Mₙ 10 kg/mol, Mw 25 kg/mol), phosphoric acid 2-hydroxyethyl methacrylate ester (HMP, 90%), dimethylamine (CH₃)₂NH, 40% in H₂O), and sodium hydroxide (ACS Reagent, pellets) were purchased from Sigma Aldrich (Milwaukee, WI, USA). Methanol (Certified ACS) was purchased from Fisher Scientific (Waltham, MA, USA). Diphenyl(2,4,6 trimethylbenzoyl)phosphine oxide (TPO, 98%) was purchased from TCI America (Philadelphia, PA, USA). Plywood substrates (¼″ BC graded sanded pine) were purchased from Home Depot (College Station, TX, USA). All aqueous solutions were prepared in 18 MΩ deionized water.

Solution Preparation and Photopolymerization. PEI (7.5 wt %) and HMP (22.5 wt %) were dissolved together in DI water and rolled overnight to homogeneity. A separate solution of TPO was prepared at 2.5 wt % in methanol. Solutions for photopolymerization were prepared by mixing PEI/HMP and TPO solutions in a 4:1 weight ratio to yield a final solution of 6% PEI, 18% HMP, and 0.5% TPO. This was done because TPO is insoluble in water, but can form a stable emulsion when pre-dissolved in organic solvents. Analogous solutions for gelation tests and gel permeation chromatography (GPC) were prepared by either leaving out PEI or replacing it with (CH₃)₂NH. Samples for GPC were prepared by casting 20 mL of solution into a 100 mm petri dish and then irradiating the dish for 5 minutes under a 100 W Blak-Ray B-100AP High Intensity 365 nm UV Lamp (UVP, Upland, CA, USA). Samples were positioned directly under the lamp, roughly 12 cm away from the light bulb. After irradiation, dishes were left to dry in a fume hood overnight. Polymerized residue was scraped off of the bottom of the dish and dissolved into a 5 mg/mL solution in DI water for analysis. Gelation of PEI/HMP and (CH₃)₂NH/HMP mixtures was tested by preparing 20 mL of solution and irradiating them under the UV lamp for 5 minutes in an uncapped scintillation vial.

Photopolymerized Coatings. Precut wood samples were shaken in DI water on an Orbi-Shaker Jr. (Benchmark Scientific, Sayreville, NJ, USA) at 150 rpm for 20 hours to remove residual sawdust and low molecular weight cellulosic fragments. After this pretreatment, the plywood was dried at 70° C. for 48 hours to establish an initial weight before coating. Plywood was soaked in still DI water overnight prior to coating to swell cell walls and improve coating uptake. Hydrated wood pieces were then immersed in the PEI/HMP/TPO solution for either 1 minute or 60 minutes. Cured samples were then exposed to 365 nm UV light for 5 minutes per side. Coated samples were subsequently rinsed for 60 minutes in stirring DI water to remove loosely adhered material.

Characterization. The molecular weight of photopolymers was determined by gel permeation chromatography (GPC) in a Tosoh EcoSEC (King of Prussia, PA, USA). Molar mass is reported relative to polyethylene oxide standards in water. Coating permeation into wood was determined with energy dispersive spectroscopy (EDS) in a JSM-7500F FE-SEM (JEOL, Tokyo, Japan). Cross-sections (ca. 5×5 mm²) were cut from the middle of the wood to avoid signal convolution from edge diffusion. Mechanical properties of wood were measured by dynamic mechanical analysis (DMA) in a TA Instruments DMA 850 (New Castle, DE, USA) in a dual cantilever arrangement. Samples were heated at 2° C./min from 100-400° C., with a strain amplitude of 100 μm and a constant strain rate of 1 Hz. After samples equilibrated at 100° C., they were held at that temperature for 10 minutes to drive off any residual moisture. Thermal stability of wood was measured by thermogravimetric analysis (TGA) in a TA Instruments Q50 TGA (New Castle, DE, USA). Samples were held isothermally at 120° C. for 20 minutes before being heated to 700° C. at a rate of 10° C./min. Samples were heated under air, with a purge flow of 60 mL/s and a balance flow of 40 mL/s nitrogen. Flammability of the wood was measured via cone calorimetry performed by the University of Dayton Research Institute. Testing was done according to ASTM 1354-17, with a heat flux of 35 kW/m² and an exhaust flow of 24 L/s.

### Photopolymer Complexation.

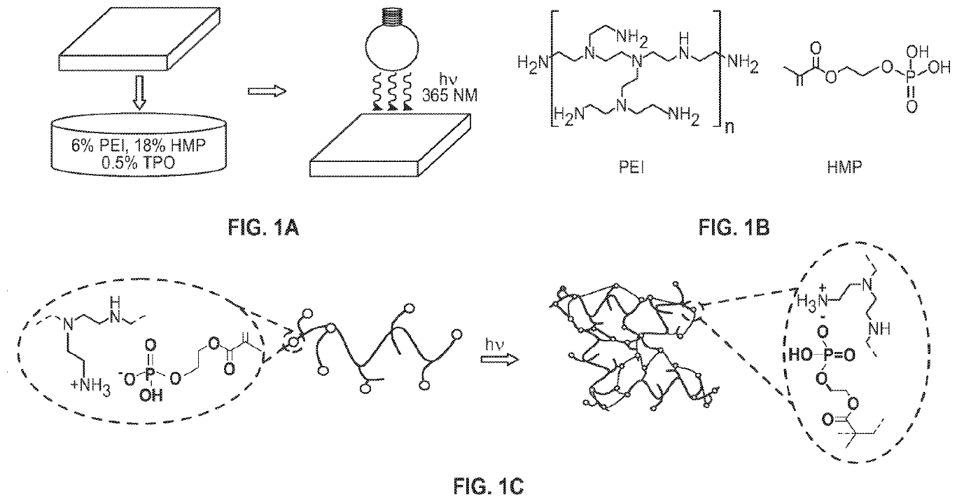

The coating process for plywood is illustrated in FIG. 1A. Samples are immersed in a mixture of PEI and HMP (shown in FIG. 1), with TPO added separately in a solution of methanol. While TPO is insoluble in water on its own, the emulsion formed when TPO is added to the polymer solution with methanol is stable for several days. TPO was chosen due to its strong absorbance near the wavelength of the UV lamp that was used. In order to control the exposure of the wood, pieces were fully immersed and allowed to soak for either 1 or 60 minutes. During this time, a salt of PEI and HMP is adsorbed onto the wood's surface, which is then cured by UV exposure into an ionically crosslinked solid when HMP polymerizes (FIG. 1C). This photo-PEC coating is water resistant and remains adhered to the wood even after rinsing in DI water. The 6:18 wt % ratio between PEI and HMP leads to a slight excess of acidic protons (from the diprotic HMP) relative to the quantity of basic amine groups from PEI. The excess acid content maximizes PEI's charge and therefore the capability of this coating to resist water exposure. Additionally, the high degree of charge on PEI minimizes the risk of aza-Michael addition between PEI's amine groups and HMP's methacrylate groups prior to polymerization, enabling a long shelf-life for the coating solution.

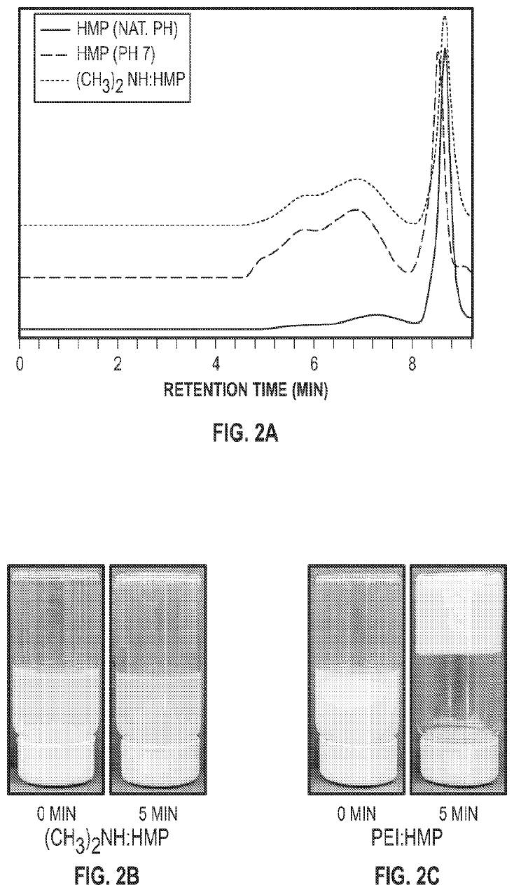

The polymerization of HMP to polyHMP (PHMP) and the resulting formation of a PEI:PHMP complex was confirmed through a combination of GPC and gelation experiments. First, four separate solutions of HMP and TPO were prepared: one with 6 wt % PEI (i.e. the solution used to coat wood), one with 6 wt % (CH₃)₂NH (a small molecule that's chemically similar to PEI's repeat unit), one with HMP at its natural pH, and one where HMP was adjusted to pH 7 with NaOH prior to addition of TPO. Each of these solutions were photopolymerized in a petri dish and allowed to dry overnight. The PEI/HMP mixture solidifies during its 5-minute exposure, but each of the other three mixtures leave water soluble products that were analyzed by GPC (FIG. 2A). The molar masses of each polymer relative to poly(ethylene oxide) standards are shown in Table 1. It is clear from these results that HMP grows to a larger molar mass when it's either neutralized or incorporated into an amine salt. This phenomenon has been seen before in the polymerization of acrylic acid, where increasing monomer ionization leads to increased monomer conversion and reaction rate. (CH₃)₂NH is chemically analogous to PEI, so the molar mass of the HMP in the PEI:HMP system can be assumed to be similar to the molar mass reported in Table 1 for (CH₃)₂NH:HMP.

TABLE 1
Molar mass data for HMP at its natural pH, neutralized
HMP, and an HMP salt of (CH₃)₂NH.

| | Mₙ | M_{w} | |
|---|---|---|---|
| | (kg/mol) | (kg/mol) | Ð |
| HMP (Natural pH) | 37 | 63 | 1.70 |
| HMP (pH 7) | 102 | 662 | 6.49 |
| (CH₃)₂NH:HMP | 93 | 439 | 4.72 |

Similar solutions to those used in the GPC experiments were also prepared in scintillation vials and exposed to UV light. The HMP salts of monomeric (CH₃)₂NH and polymeric PEI were compared to study the influence of cation size on solution gelation. The results of 5 minutes of irradiation are shown in FIG. 2B and FIG. 2C. The vials were turned upside-down after irradiation, allowing a liquid sample to flow to the cap of the vial, while the gelled sample in FIG. 2C is unable to flow. This gelation provides further evidence that a solid polyelectrolyte complex between PEI and PHMP forms when the PEI/HMP/TPO mixture is exposed to UV light.

### Coating Morphology.

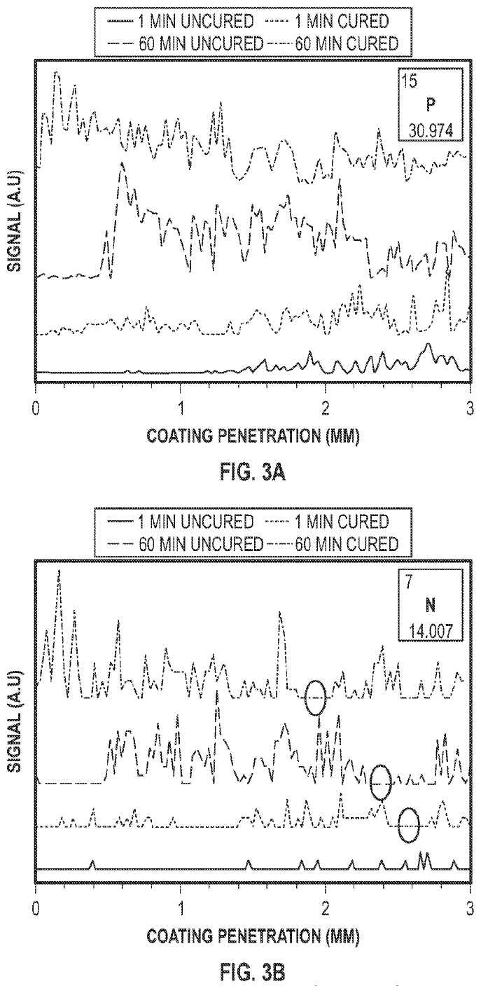

The depth of coating penetration was measured by energy dispersive spectroscopy (EDS) in a scanning electron microscope (SEM). Cross sections of coated wood samples (both cured and uncured) were probed for the presence of phosphorus and nitrogen. Neither of these elements appear in significant amounts in wood naturally, and their presence indicates coating infiltration into the wood. The results of the EDS experiments are shown in FIG. 3. It is apparent from these data that the depth of penetration for phosphorus is significantly greater than for nitrogen. This is explained by the fact that HMP is both a small molecule and significantly more abundant than PEI in the dip solution, lending to more ready diffusion into the wood.

Comparing the uncured (red, orange) and cured (blue, green) traces further helps to understand the role that the UV treatment plays in this coating system. Each of these systems were subjected to 1-hour rinses following the application of the coating. It is clear from the uncured traces that the abundance of phosphorus or nitrogen near the surface of the wood decreases substantially. The lack of P/N near the exterior is more dramatic in the samples that were dipped for 60 minutes since more material is taken up. Even though the penetration of the UV light into the wood is very limited, the coating that is formed from the UV exposure at the surface has a protective effect to the underlying material which prevents leaching out of either PEI or unreacted HMP. This is important for potential commercial application of a coating system like this, because it eliminates the necessity for time-intensive curing steps based on immersion in a buffered solution.

Another observation from this experiment is the influence of the layered structure of plywood. The plywood used in this study is ca. 6 mm thick, with three plies. This yields a ply thickness of ˜2 mm. There is a clear gap in signal visible on all of the nitrogen EDS data except for the uncured 1-minute dip sample. The lack of signal for the uncured 1-minute system is likely due to its poor signal-to-noise ratio because of the short immersion. For the other three traces, a gap is visible in the signal between ˜2 and 3 mm penetration. A similar gap is not observed in any of the phosphorus traces. The glue between plies may prevent the diffusion of a large molecule like PEI, while allowing easier diffusion of HMP.

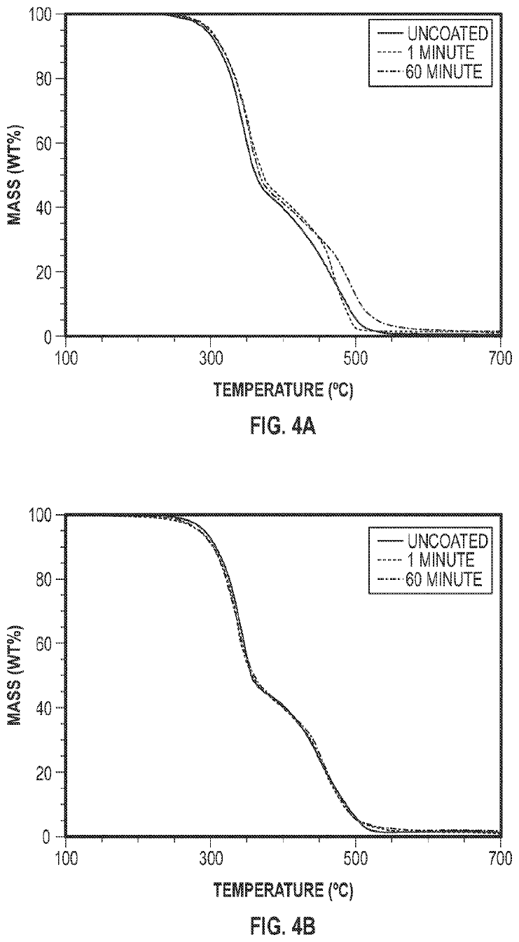

The extent of the between-ply diffusion was investigated further via thermogravimetric analysis (TGA). The TGA data for the outer and inner plies of coated plywood samples are shown in FIGS. 4A-B. The data for the outer ply shown in FIG. 4A shows a clear difference between the uncoated, 1-minute, and 60-minute dip photocured wood samples. High char yield is expected for a flame retardant coating designed to protect a substrate from fire exposure. The increase in char yield is greater for the samples that were coated longer, correlating with a larger amount of coating. None of these trends are observed for the inner ply. This suggests that while there is some penetration into the inner ply of the assembly (as indicated by EDS), the amount of coating deposited is not significant enough to affect the fire behavior of that inner layer of wood. The coating being localized primarily to the exterior of the assembly suggests that there is a possibility to utilize spray coating as a way to deposit this treatment more quickly.

### Fire Behavior of Coated Wood.

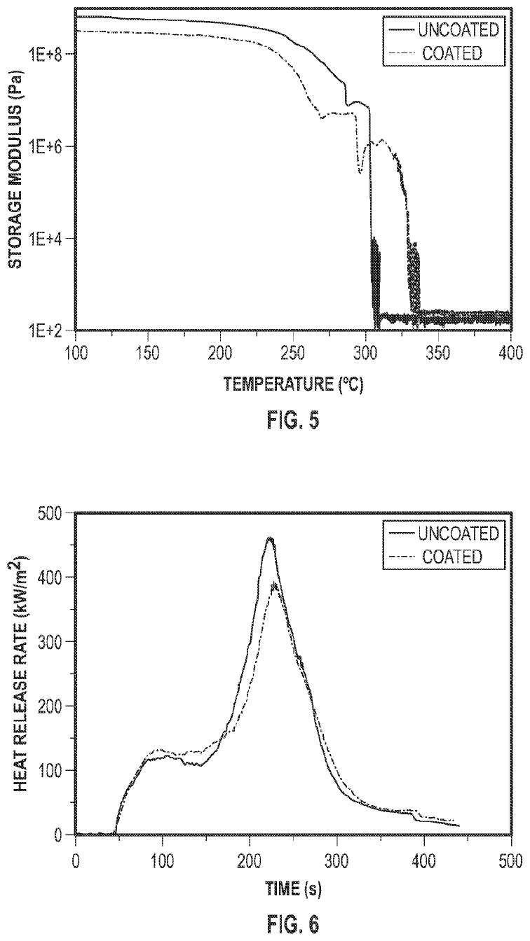

Since wood acts in a load bearing capacity in many applications (e.g. home construction), it is important to evaluate the impact of the photopolymer coating on the plywood's mechanical strength. Dynamic mechanical analysis (DMA) was chosen for this task, as it can measure flexural modulus over a wide temperature range. In this study, coated and uncoated samples were both subjected to oscillatory strain in a dual cantilever arrangement (similar to a 3-point bend) from 100-400° C. The lower range was chosen to ensure the plywood was dry, while the higher end was utilized to ensure that the first degradation step of the wood (observed in the TGA data shown in FIGS. 4A-B) was completed. The results of the DMA experiments are shown in FIG. 5.

The DMA data shows a slight decrease in flexural modulus for the coated wood. This has not been observed in previous polyelectrolyte complex treatments for wood. It is possible that the glue which holds the plywood together is weakened by the coating process and is responsible for the decrease in modulus. The EDS data shown in FIGS. 3A-B gives reason to suspect at least the HMP is present in the glue and could be responsible for this decreased stiffness. It can also be seen from FIG. 5 that the coated wood begins to mechanically weaken at a lower temperature than uncoated wood. This is similar to what is observed in TGA data for other coatings on wood and a variety of other substrates. The beginning of the intumescent mechanism catalytically dehydrates the cellulose of wood and forms char, which is likely responsible for this earlier onset of mechanical weakness. The mechanical strength of coated wood is better retained as temperature further increases, ultimately surpassing that of the uncoated wood at ˜300° C. The plot shows that both samples ultimately undergo complete mechanical failure as temperature increases, with a sudden drop in modulus of ˜10⁴ Pa. The coated wood experiences this drop 30° C. later than the uncoated wood, suggesting that materials coated with this system can retain their mechanical properties for longer at high temperatures. It is possible that the dehydration and char formation mechanism acts to reinforce the glue holding the plywood together. The expanded char that forms from the intumescence may fill voids in the plywood and strengthen the material against failure at high temperatures. This could potentially delay or prevent building collapses.

Finally, cone calorimetry experiments were carried out to quantify the influence that the PEI/HMP coating has on the heat release characteristics of wood. Traces of representative cone calorimetry data are shown in FIG. 6, with the results tabulated in Table 2. The degradation profile of the wood doesn't change significantly early in combustion. The coated samples had a slightly lower time to ignition (TTI), but all samples exhibit a small peak with a short plateau after ignition. This is likely the initial charring of the surface after ignition which creates a barrier to the underlying wood and leads to less continued combustion. Continued exposure to heat flux eventually breaks down this char, leading to a much more significant release of heat. The coated wood has a peak heat release rate (pkHRR) that is a modest 13% reduction relative to the uncoated plywood. The pkHRR is commonly viewed as the most important single metric in flame retardant testing, since it is correlated with the ability of a burning object to give off heat to its surroundings and propagate a fire. The total heat release (THR), which is the integral of pkHRR over time, is reduced by 4% in the coated wood. A stable THR is common in flame retarded substrates, as many flame retardants on both wood and other substrates act to decrease the pkHRR and spread that degradation out over a longer period of time. Since this treatment adds a small amount of weight to the wood (1.6 wt %), it is likely that these values could be further improved upon by adding additional coating, either through increasing the solids content of the dip step or by applying sequential coatings, as the UV-cured PEI/HMP film is durable to solution exposure after polymerization and complexation. The coating solution is sufficiently low viscosity that it should be amenable to pressure treatment systems commonly used for wood. This will likely also improve the speed of coating deposition and improve its commercial potential.

TABLE 2
Cone calorimetry data for uncoated and coated plywood.

| | Uncoated | Coated | % |
|---|---|---|---|
| | Wood | Wood | Change |
| Weight Gain (wt %) | — | 1.6 ± 0.3 | — |
| TTI (s) | 58 ± 9 | 50 ± 3 | −14% |
| pkHRR (kW/m²) | 470 ± 10 | 410 ± 30 | −13% |
| THR (MJ/m²) | 53 ± 2 | 51 ± 2 | −4% |
| TSR (m²/m²) | 240 ± 140 | 106 ± 15 | −56% |
| FIGRA | 2.10 ± 0.06 | 1.76 ± 0.08 | −16% |

The coated plywood's 56% decrease in total smoke release (TSR) is of particular note for this coating. Previously published polyelectrolyte treatments on wood have not accomplished this level of TSR reduction. Typically, polyelectrolyte based coatings necessitate the addition of ceramic platelets (e.g. nanoclays) to effectively reduce TSR. Since PEI is a common component of these intumescent polyelectrolyte treatments, it is likely that the incorporation of HMP is the key factor in this TSR reduction. This may be a result of the high oxygen content of HMP's acrylate backbone leading to cleaner combustion as the coating and underlying wood degrade. The coated wood also has a lower fire growth rate (FIGRA), indicating that it reaches its pkHRR further after ignition than the uncoated wood. This is desirable as it means the coated material will take longer to propagate fire to its surroundings.

### Example 2

In this Example, a UV-cured PEC coating was optimized by decreasing the PEI molecular weight and increasing the solids content of the coating solution, resulting in higher weight gains and improved flame retardant properties while preserving the mechanical properties of both natural wood and plywood. Cone calorimetry demonstrated that the total heat release, average heat release rate, and MARHE were decreased for both substrates as compared to uncoated wood, and the peak heat release rate and total heat release values were significantly reduced in plywood as compared with the originally published photoPEC coating. EDS and TGA experiments revealed that complete saturation of the wood was achieved where it was not previously. This coating presents an effective, environmentally benign, and scalable method for the flame-retardant treatment of wood. Further work could include the optimization of dip times to achieve saturation of different commonly used wood thicknesses, and the investigation of pressure treatments to deposit the coating more rapidly.

Materials. Polyethyleneimine (PEI) with molecular weights (Mw) of 800 and 25,000 g/mol was purchased from Sigma Aldrich (St. Louis, MO). Each PEI will be termed PEI₈₀₀ and PEI_{25K}, respectively. Phosphoric acid 2-hydroxyethyl methacrylate ester (HMP, 90%) was purchased from Sigma Aldrich (St, Louis, MO). Methanol was purchased from Fisher Scientific (Waltham, MA). Diphenyl(2,4,6 trimethylbenzoyl)phosphine oxide (TPO, >98.0%) was purchased from TCI America (Portland, OR). Plywood (¼″ BC graded sanded pine) and natural wood (premium kiln-dried whitewood stud) were purchased from Home Depot (College Station, TX, USA) and cut into 2.5×10×0.64 cm pieces. Aqueous solutions were prepared using 18 MΩ deionized (DI) water. Coated samples were cured with a 100 W Blak-Ray B-100AP High Intensity 365 nm UV Lamp (UVP, Upland, CA, USA). The intensity of the lamp was measured to be approximately 200 mW/cm² using a Thorlabs PM100D optical power meter (Newton, NJ).

Solution Preparation. PEI and HMP were dissolved together in DI water at the desired weight percentages and rolled overnight. A solution of 5 weight percent (wt %) TPO in methanol was prepared separately and rolled for 5 minutes to dissolve. Coating solutions were prepared by mixing the PEI/MP solution and the TPO solution in a 4:1 mass ratio to yield a solution containing 1 wt % TPO and varying wt % s PEI and HMP. This was done because TPO is insoluble in water, but can form a stable emulsion when first dissolved in an organic solvent, then mixed into an aqueous solution.

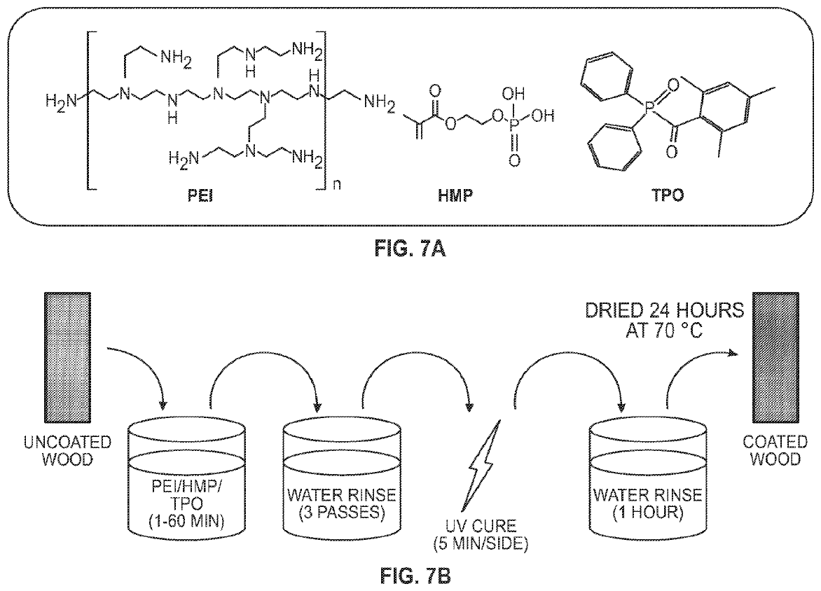

Coating Deposition. Cut wood pieces were rolled in DI water for 72 hours prior to coating to remove sawdust and any loosely adhered fragments. Pieces were dried at 70° C. for 48 hours. Wood samples were then shaken in the PEI/HMP/TPO coating solution for 1-60 minutes on an Orbitrap Shaker Jr. (Benchmark Scientific, Sayreville, NJ, USA) at 150 rpm. After coating deposition, excess coating was removed by passing each wood piece through a DI water rinse three times. Each sample was cured under the UV lamp for 5 minutes, then flipped over and cured for five minutes on the opposite side. Samples were positioned approximately 12 cm below the lamp bulb during curing. After curing, coated pieces were rolled in DI water for 1 hour to remove any loosely adhered coating, dried at 70° C. for 24 hours, then stored in a drybox until characterization. FIG. 7A illustrates chemical structures of various materials used, and the coating process is summarized in FIG. 7B.

Characterization. Flame tests were performed by applying a flame to the bottom of a vertically hung wood sample (2.5×10×0.64 cm) using a Bunsen burner (H-5890, Humboldt Mfg. Co., Elgin, IL, USA) with an outer cone flame length of 2 cm. The tip of the burner was positioned 1 cm below the sample for 10 s, then removed until flaming combustion stopped, then applied for an additional 10 s. The first, second, and total afterburn times were recorded, and the residue was tabulated.

Scanning electron microscope (SEM) images of the surface of uncoated wood, pre-burn coated wood and post-burn coated wood were obtained using a Model JSM-7500F FESEM (JEOL, Tokyo, Japan) after they were sputter coated with 5 nm of palladium-platinum alloy. Coating penetration into the wood was analyzed via energy dispersive X-ray spectroscopy (EDS) data from the same SEM instrument. Cross section samples for EDS were cut from the center of coated wood samples to ensure that P and N signals were the result of coating bulk diffusion rather than diffusion through sample edges. Thermogravimetric analysis (TGA) was performed using a Q-50 thermogravimetric analyzer (TA Instruments, New Castle, DE, USA). Samples were heated isothermally at 120° C. for 20 minutes to remove any residual water, after which the temperature was increased by 10° C./min up to 700° C. under a flow of either 60 mL/s air or 60 mL/s nitrogen. Samples for TGA were cut from the interior and exterior of coated and uncoated wood. Three-point bending tests were conducted with an MTS Insight electromechanical testing system (MTS Systems Corporation, Eden Prairie, MN, USA) utilizing a 30 kN load cell, with a spacing of 5.1 cm between the lower points. The coated wood pieces (5.1×10×0.64 cm) were allowed to equilibrate in the mechanical testing room for one week prior to testing.

Cone calorimetry was conducted by the University of Dayton Research Institute in accordance with ASTM E-1354-22, at a heat flux of 35 kW/m² with an exhaust flow of 24 L/s. Coated and uncoated wood samples were wrapped in aluminum foil on one side as per the procedure. No frame or grid was used for the thicker natural wood samples (10×10×2 cm). The thinner plywood samples (10×10×0.7 cm) were testing using a frame and grid to prevent curling.

### Photopolymer Complexation.

TPO was used as the photoinitiator as it absorbs at 368 nm, a wavelength similar to that of the UV lamp used (365 nm). The PEI/HMP/TPO solution had a pH of 6-7 which rendered PEI and HMP partially cationic and anionic, respectively: The primary, secondary, and tertiary amine groups of PEI have pKas of 4.5, 6.7, and 11.6 respectively, so at a pH of 6-7 the secondary and tertiary amines are expected to be protonated and thus positively charged. The phosphate groups of HMP are expected to have pKas around 2, 7 and 12 (pKa 1, 2, and 3), so at a pH of 6-7 the phosphate groups of HMP are predicted to be singly deprotonated, resulting in a negative charge. The resulting electrostatic attraction between the deprotonated phosphate group of HMP and the positively charged amine groups of PEI are hypothesized to form an ionically bound polyelectrolyte-small molecule “complex”. After absorption into the wood substrate, HMP is photopolymerized, transforming the polyelectrolyte-small molecule complex into a polyelectrolyte-polyelectrolyte complex coating which is resistant to rinsing off in water due to the strong electrostatic interactions between PEI and poly(HMP). The 1:3 weight percent ratio of PEI:HMP was chosen to reduce the likelihood of Michael addition between PEI's primary amine groups and the methacrylate groups on HMP.

### Coating Optimization.

Solutions of 6 wt % PEI/18 wt % HMP/1 wt % TPO were prepared using PEI_{25K} and PEI₈₀₀ and coated on plywood with a 60-minute dip. Coating solutions will be denoted with the wt % of PEI and the PEI Mw (“6% PEI_{25K}” and “6% PEI_{800K}” respectively). The 6% PEI₈₀₀ coating resulted in a similar weight gain and slightly poorer flame test performance as compared with the 6% PEI_{25K} coating (Table 3). Next, a higher solids content solution of 14 wt % PEI₈₀₀/42 wt % HMP/1 wt % TPO (“14% PEI₈₀₀”) was prepared and coated on plywood with a 60-minute dip time. 14 wt % PEI_{25K}/42 wt % HMP/1 wt % TPO (“14% PEI_{25K}”) was not prepared as PEI_{25K} was not soluble at 14 wt %.

The 14% PEI₈₀₀ coating resulted in a 26.8% higher weight gain and an almost 8× shorter afterburn than the 6% PEI₈₀₀ coating in a vertical flame test. Thus, increasing solution solids content was found to directly increase coating deposition. It is believed that the higher concentrations of PEI and HMP increase the amount of material available to be absorbed into the wood substrate. Furthermore, decreasing the PEI molecular weight from 25 kg/mol to 800 g/mol was found to indirectly improve coating deposition by allowing for the creation of a more highly concentrated coating solution.

Finally, 14% PEI₈₀₀ was deposited on plywood and natural wood with dip times varying from one to 60 minutes to investigate the effect of coating deposition time on weight gain and flame retardant performance. Weight gain and fire-retardant performance were generally observed to improve with increased dip times, which is consistent with previous PEC coatings for wood. Longer dip times are believed to improve coating deposition by allowing more time for polyelectrolyte adsorption onto the substrate.

TABLE 3
Weight gain and fire behavior as a function of recipe,
substrate, dip time, and PEI molecular weight.

| | | Dip | | Weight | Total | Post-burn |
|---|---|---|---|---|---|---|
| | | Time | PEI M_{w} | Gain | Afterburn | Residue |
| Recipe | Substrate | (min) | (g/mol) | (%) | (s) | (%) |
| Uncoated | Plywood | — | — | — | 182 ± 23 | 18.4 ± 2.1 |
| | Natural | — | — | — | 170 ± 40 | 21.7 ± 1.9 |
| | Wood | | | | | |
| 6% PEI/18% | Plywood | 60 | 25,000 | 15.3 ± 3.5 | 17 ± 23 | 100.1 ± 0.8 |
| HMP/1% | Plywood | 60 | 800 | 16.4 ± 2.0 | 47 ± 31 | 94.4 ± 7.1 |
| TPO | | | | | | |
| 14% PEI/ | Plywood | 1 | 800 | 13.5 ± 3.1 | 19 ± 19 | 99.7 ± 1.7 |
| 42% HMP/ | Plywood | 10 | 800 | 14.6 ± 3.2 | 78 ± 126 | 78.9 ± 36.4 |
| 1% TPO | Plywood | 30 | 800 | 21.1 ± 4.5 | 26 ± 41 | 97.7 ± 4.7 |
| | Plywood | 60 | 800 | 20.8 ± 3.8 | 6 ± 9 | 99.6 ± 0.3 |
| | Natural | 1 | 800 | 12.9 ± 2.2 | 89 ± 26 | 91.4 ± 2.1 |
| | Wood | | | | | |
| | Natural | 10 | 800 | 15.7 ± 3.8 | 93 ± 35 | 89.4 ± 4.0 |
| | Wood | | | | | |
| | Natural | 30 | 800 | 15.5 ± 3.8 | 79 ± 33 | 89.5 ± 6.9 |
| | Wood | | | | | |
| | Natural | 60 | 800 | 21.2 ± 5.2 | 45 ± 45 | 94.8 ± 1.6 |
| | Wood | | | | | |

The coating that was characterized was the 1400 PEI₈₀₀ coating solution with a 60-minute dip on plywood and natural wood, as it showed the highest weight gain (20.80% and 21.2%, respectively) and highest reduction in afterburn time in the screening flame test (9700 and 7400 respectively).

### Coating Deposition.

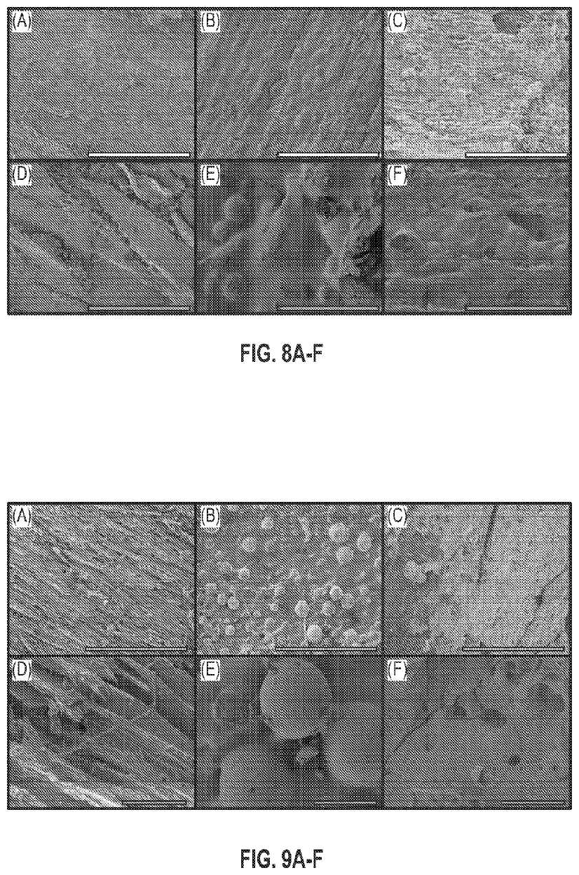

FIGS. 8A-F shows SEM images of uncoated and coated natural wood before and after burning (scale bars in 8A-8C are 1 mm and scale bars in 8D-8F are 100 μm). The uncoated sample exhibits the porous and rough surface expected of wood, while the coated sample appears glossier and smoother due to the presence of the coating on the surface. Filled globules are observed across the coated surface; this microstructure is typical of an emulsion-based coating. After burning, empty bubbles are observed across the wood surface. These bubbles are on a smaller scale than the globules observed before burning; they can be attributed to the microintumescent mechanism of the flame retardant coating. Upon flame exposure, polyHMP is expected to thermally degrade to release phosphoric acid, which dehydrates the carbon-rich wood substrate to produce a protective aromatic char layer. As this occurs, the PEI degrades to release inert gases, such as nitrogen and ammonia, that expand the char to further protect the underlying substrate. This results in the appearance of bubbles on the surface of the substrate. Plywood exhibits a similar effect, as shown in FIGS. 9A-F (scale bars in 9A-9C are 1 mm and scale bars in 9D-9F are 100 μm).

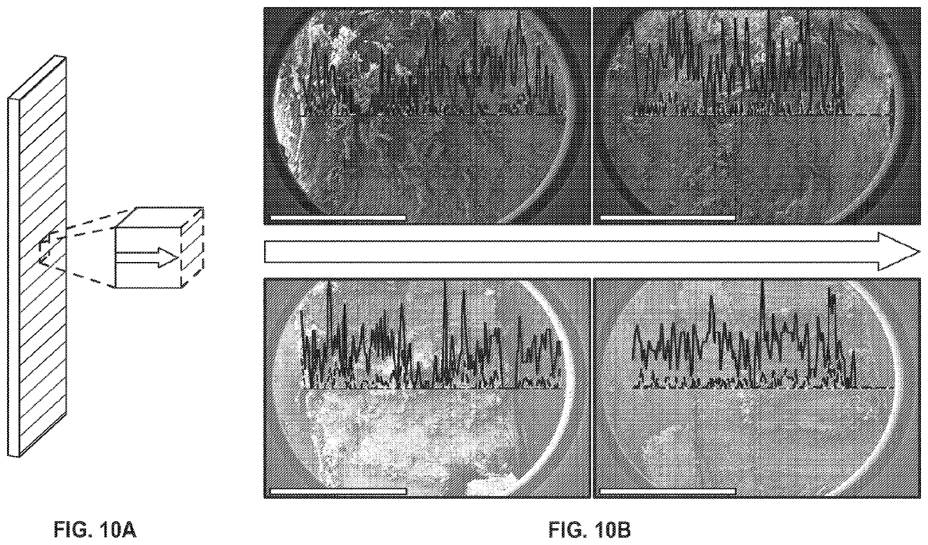

EDS data suggests that the coating is not only present on the surface of the wood, but throughout the bulk of the material. FIG. 10A illustrates a schematic showing preparation of samples for EDS. FIG. 10B maps the linear density of phosphorus and nitrogen from left to right across internal cross-sections of coated natural wood (top plots) and plywood (bottom plots) (scale bars are 2 mm). Phosphorus and nitrogen are not major components of untreated wood, so their presence can be attributed to the presence of the PEC coating: HMP and TPO contain phosphorus while PEI contains nitrogen. Relatively constant values across each cross section indicate complete saturation of the sample by the coating, which was not observed in the previous work. It is important to note that the signal for nitrogen is relatively weak because light elements (atomic number <11) produce longer-wavelength X-rays that are more easily absorbed by the sample, so the difference in intensities between nitrogen and phosphorus is not necessarily indicative of the ratio of these components to each other.

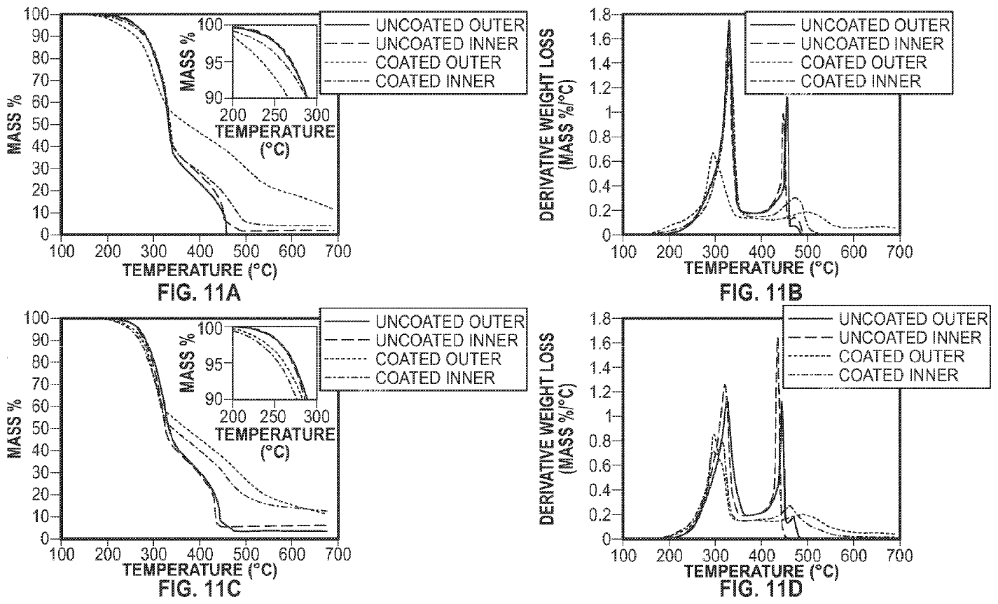

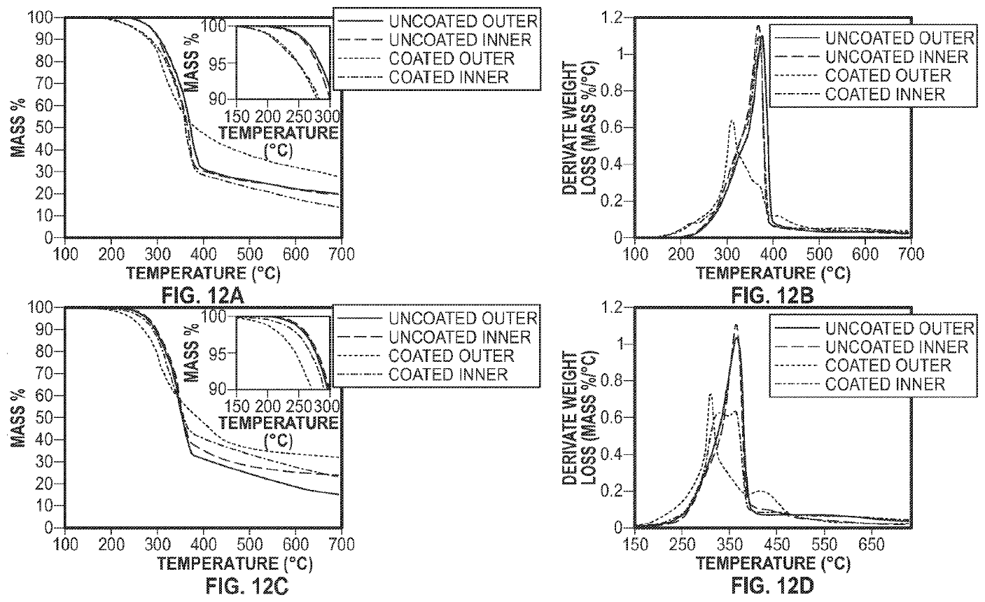

Thermogravimetric analysis (TGA) was performed to confirm the presence of the coating throughout the bulk of the coated wood. FIGS. 11A-D depict thermograms showing the mass loss and derivative mass loss as a function of temperature for exterior (“outer”) and interior (“inner”) pieces of coated and uncoated natural wood and plywood under air. FIGS. 12A-D depict thermograms showing the mass loss and derivative mass loss as a function of temperature for exterior (“outer”) and interior (“inner”) pieces of coated and uncoated natural wood and plywood under nitrogen. The two-part degradation mechanism observed is typical of wood, as hemicelluloses degrade around 300° C. and cellulose degrades above 350° C., with lignin degrading across a broad range of about 200 to 500° C. For the exterior of coated natural wood, the first degradation event occurred about 35° C. earlier than the uncoated wood, and its derivative peak was much lower. This earlier onset of degradation indicates the formation of protective char and a slower rate of degradation as a result of the PEC coating. The second-stage degradation peaks were significantly delayed and reduced in intensity for both the inner and outer coated natural wood. It is likely that more coating is present on the surface of the wood than the interior, though the change in the second degradation peak for the interior coated wood indicates that the coating is present to some extent throughout the bulk of the material, as suggested by EDS. The coated plywood samples showed a similar effect, though the initial degradation peak was lowered and occurred earlier than uncoated plywood for both the inner and outer coated samples, suggesting complete saturation of the coating throughout the material. This contrasts with the previous work in which the inner ply of coated plywood showed no change from uncoated wood in TGA. This improvement may be attributed to the approximately 30× reduction in the PEI molecular weight, leading to improved absorption into the wood pores.

### Flame Retardant Performance.

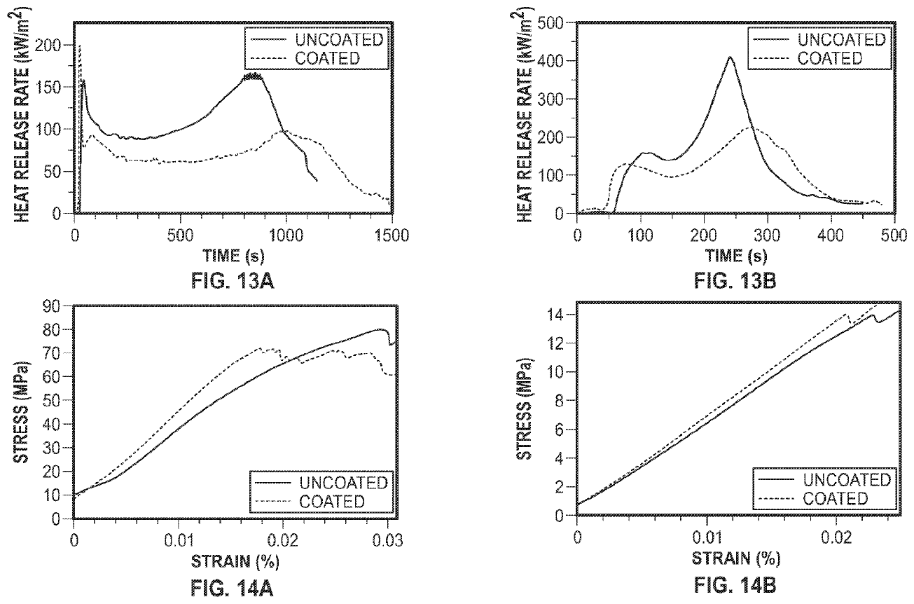

Cone calorimetry experiments were carried out to demonstrate the flame retardancy of the coated wood. Representative heat release rate curves for coated and uncoated wood are shown in FIGS. 13A-B and tabulated results in Table 4. Uncoated natural wood showed a bimodal heat release peak typical of a thermally thick charring material. Coated natural wood showed a similar bimodal heat release peak. The initial heat release peak increased with the presence of the coating, likely due to ignition of the coating itself. The second heat release peak, which can be attributed to char burn-through, was significantly lowered and delayed. This suggests that the coated sample quickly began producing char, slowing down heat release and mass loss for the duration of the test. The coating increased the char yield of natural wood by 27%, decreased the total heat release by 17%, and decreased the Maximum Average Rate of Heat Emission (MARHE) by 39%, indicating that the coated material is less likely to spread fire to other objects during combustion. Due to the increase in heat release rate of the initial char formation peak, the peak heat release rate of the coated natural wood increased by 19% with respect to the uncoated wood. It is important to note that peak heat release rate, while is has been used as a metric to describe the flammability of an object, may not accurately represent the behavior of the sample as it is a single value. Average heat release rate is considered to be a more useful metric to predict full-scale fire behavior, including full-scale peak heat release rate. The average heat release rate throughout the test was decreased by 41% with the addition of the coating on natural wood.

The uncoated plywood heat release rate curve shows a high second peak, indicating that stable char is not formed. The heat release peaks for the coated material are lower and more spread, indicating more stable char formation as the curve becomes more typical of a thermally thick charring material. Like natural wood, coated plywood showed a significant 92% increase in char yield and decreases in total heat release, MARHE, and average heat release rate of 19%, 28%, and 14% respectively. The peak heat release rate was also decreased in plywood by 47% with the application of the coating. This represents a significant improvement to the previous study of this photopolymerized PEC, in which total heat release and peak heat release rates were reduced by only 4% and 13%, respectively.

TABLE 4
Cone calorimetry data for uncoated and
coated natural wood and plywood.

| | Parameters | | | | |
|---|---|---|---|---|---|
| | Char | | Avg | | |
| | Yield | pkHRR | HRR | THR | MARHE |
| Sample | (%) | (kW/m²) | (kW/m²) | (MJ/m²) | (kW/m²) |
| Uncoated | 20.5 ± | 173 ± | 106.9 ± | 119.1 ± | 232 ± |
| Natural | 4.1 | 8 | 5.7 | 7.7 | 14 |
| Wood | | | | | |
| Coated | 26.0 ± | 206 ± | 63.1 ± | 98.6 ± | 141 ± |
| Natural | 1.0 | 10 | 1.9 | 0.2 | 51 |
| Wood | | | | | |
| Change | +27% | +19% | −41% | −17% | −39% |
| Uncoated | 20.7 ± | 410 ± | 125.0 ± | 55.9 ± | 332 ± |
| Plywood | 0.7 | 24 | 1.9 | 1.1 | 7 |
| Coated | 39.7 ± | 218 ± | 106.9 ± | 47.0 ± | 239 ± |
| Plywood | 8.4 | 11 | 5.7 | 4.6 | 14 |
| Change | +92% | −47% | −14% | −19% | −28% |

### Mechanical Properties.

Three-pointing bending tests were carried out with coated and uncoated wood to determine the effect of the coating on the substrate's mechanical properties. FIG. 14A illustrates three-point bending data as a plot of representative stress versus strain for natural wood. FIG. 14B illustrates three-point bending data as a plot of representative stress versus strain for plywood. Data is tabulated in Table 5. The coating resulted in statistically insignificant changes in flexural strength for both natural wood and plywood. Similarly, the flexural moduli of natural wood and plywood show minor but insignificant increases with the coating. This slight increase in the flexural modulus may be due to the coating increasing the density of the wood by filling its pores. The data suggests that the coating does not significantly affect the mechanical properties of wood.

TABLE 5
Three-point bending data for uncoated
and uncoated natural wood and plywood.

| | Flexural Strength | Flexural Modulus |
|---|---|---|
| Sample | (MPa) | (MPa) |
| Uncoated Natural Wood | 20.5 ± 4.1 | 173 ± 8 |
| Coated Natural Wood | 26.0 ± 1.0 | 206 ± 10 |
| Uncoated Plywood | 20.7 ± 0.7 | 410 ± 24 |
| Coated Plywood | 39.7 ± 8.4 | 218 ± 11 |

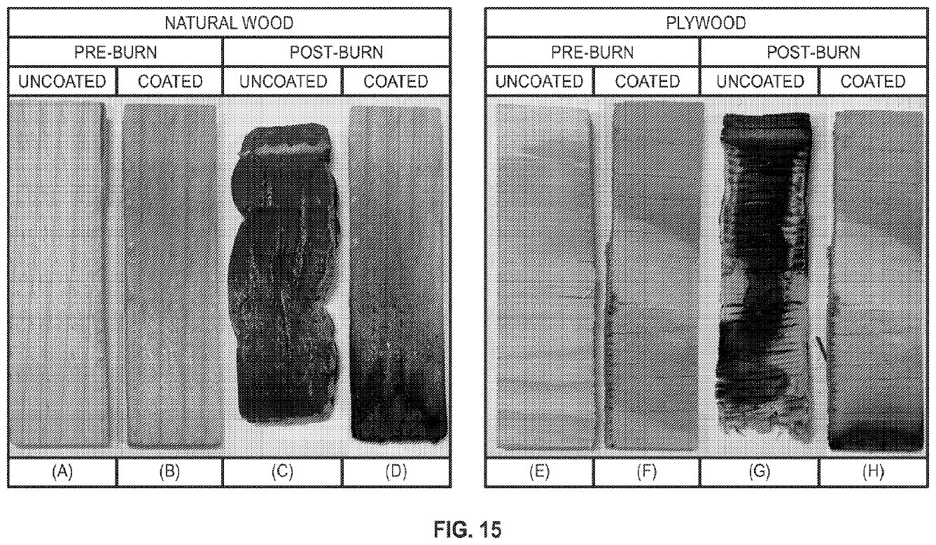

FIG. 15 illustrates digital images of (a, c, e, g) uncoated and (b, d, f, h) coated (a-d) natural wood and (e-h) plywood (a, b, e, f) before and (c, d, g, h) after flame testing.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### Exemplary Aspects

The following exemplary aspects are provided, the numbering of which is not to be construed as designating levels of importance:

Aspect 1 provides a flame-retardant treatment composition comprising:
polyamine;
a phosphoric acid methacrylate ester; and
a photoinitiator.

Aspect 2 provides the flame-retardant treatment composition of Aspect 1, wherein the polyamine is 10 wt % to 40 wt % of the composition on a dry weight basis.

Aspect 3 provides the flame-retardant treatment composition of any one of Aspects 1-2, wherein the polyamine is 20 wt % to 30 wt % of the composition on a dry weight basis.

Aspect 4 provides the flame-retardant treatment composition of any one of Aspects 1-3, wherein the polyamine is 1 wt % to 25 wt % of the composition.

Aspect 5 provides the flame-retardant treatment composition of any one of Aspects 1-4, wherein the polyamine is 5 wt % to 15 wt % of the composition.

Aspect 6 provides the flame-retardant treatment composition of any one of Aspects 1-5, wherein the polyamine has a weight-average molecular weight of 100 g/mol to 1,000,000 g/mol.

Aspect 7 provides the flame-retardant treatment composition of any one of Aspects 1-6, wherein the polyamine has a weight-average molecular weight of 100 g/mol to 5,000 g/mol.

Aspect 8 provides the flame-retardant treatment composition of any one of Aspects 1-7, wherein the phosphoric acid methacrylate ester is 50 wt % to 90 wt % of the composition on a dry weight basis.

Aspect 9 provides the flame-retardant treatment composition of any one of Aspects 1-8, wherein the phosphoric acid methacrylate ester is 65 wt % to 80 wt % of the composition on a dry weight basis.

Aspect 10 provides the flame-retardant treatment composition of any one of Aspects 1-9, wherein the phosphoric acid methacrylate ester is 5 wt % to 70 wt % of the composition.

Aspect 11 provides the flame-retardant treatment composition of any one of Aspects 1-10, wherein the phosphoric acid methacrylate ester is 10 wt % to 50 wt % of the composition.

Aspect 12 provides the flame-retardant treatment composition of any one of Aspects 1-11, wherein the phosphoric acid methacrylate ester comprises phosphoric acid 2-hydroxyethyl methacrylate ester (HMP), bis[2-(methacryloyloxy)ethyl]phosphate, or a combination thereof.

Aspect 13 provides the flame-retardant treatment composition of any one of Aspects 1-12, wherein the phosphoric acid methacrylate ester is phosphoric acid 2-hydroxyethyl methacrylate ester (HMP).

Aspect 14 provides the flame-retardant treatment composition of any one of Aspects 1-13, wherein a weight ratio of the polyamine to the phosphoric acid methacrylate ester is 1:1 to 1:10.

Aspect 15 provides the flame-retardant treatment composition of any one of Aspects 1-14, wherein a weight ratio of the polyamine to the phosphoric acid methacrylate ester is 1:2 to 1:4.

Aspect 16 provides the flame-retardant treatment composition of any one of Aspects 1-15, wherein the photoinitiator is 0.1 wt % to 10 wt % of the composition on a dry weight basis.

Aspect 17 provides the flame-retardant treatment composition of any one of Aspects 1-16, wherein the photoinitiator is 1 wt % to 5 wt % of the composition on a dry weight basis.

Aspect 18 provides the flame-retardant treatment composition of any one of Aspects 1-17, wherein the photoinitiator is 0.1 wt % to 5 wt % of the composition.

Aspect 19 provides the flame-retardant treatment composition of any one of Aspects 1-18, wherein the photoinitiator is 0.5 wt % to 2 wt % of the composition.

Aspect 20 provides the flame-retardant treatment composition of any one of Aspects 1-19, wherein the photoinitiator is diphenyl(2,4,6 trimethylbenzoyl)phosphine oxide (TPO), phenylbis(2,4,6-trimethylbenzoyl)phosphine oxide, 2-hydroxy-2-methylpropiophenone, 2-hydroxy-4′-(2-hydroxyethoxy)-2-methylpropiophenone, lithium phenyl-2,4,6-trimethylbenzoylphosphinate (Li-TPO), ethyl phenyl(2,4,6-trimethylbenzoyl)phosphinate (TPO-L), camphorquinone, or a combination thereof.

Aspect 21 provides the flame-retardant treatment composition of any one of Aspects 1-20, wherein the photocatalayst is diphenyl(2,4,6 trimethylbenzoyl)phosphine oxide (TPO).

Aspect 22 provides the flame-retardant treatment composition of any one of Aspects 1-21, further comprising a solvent.

Aspect 23 provides the flame-retardant treatment composition of Aspect 22, wherein the solvent comprises an aqueous solvent, an organic solvent, or a combination thereof.

Aspect 24 provides the flame-retardant treatment composition of any one of Aspects 22-23, wherein the solvent comprises water, an alcohol, or a combination thereof.

Aspect 25 provides the flame-retardant treatment composition of any one of Aspects 1-24, wherein the composition has a pH of 5 to 8.

Aspect 26 provides the flame-retardant treatment composition of any one of Aspects 1-25, wherein the composition has a pH of 6 to 7.

Aspect 27 provides the flame-retardant treatment composition of any one of Aspects 1-26, wherein the polyamine comprises polyethylenimine (PEI), poly(allylamine), poly(vinylamine), chitosan, a salt thereof, or a combination thereof.

Aspect 28 provides the flame-retardant treatment composition of any one of Aspects 1-27, wherein the polyamine comprises polyethylenimine (PEI).

Aspect 29 provides a method of applying a flame-retardant treatment composition comprising:
applying the flame-retardant treatment composition to a substrate;
curing the composition on the substrate comprising exposing the composition on the substrate to light (e.g., visible light, UV light, IR light, or a combination thereof).

Aspect 30 provides the method of Aspect 29, further comprising rinsing the substrate in an aqueous solvent after the applying and before the curing, after the curing and before any drying, or a combination thereof.

Aspect 31 provides the method of any one of Aspects 29-30, wherein applying the flame-retardant treatment composition to the substrate comprises immersing the substrate in the flame-retardant treatment composition.

Aspect 32 provides the method of any one of Aspects 29-31, wherein applying the flame-retardant treatment composition to the substrate comprises immersing the substrate in the flame-retardant treatment composition for a duration of 1 sec to 48 hours.

Aspect 33 provides the method of any one of Aspects 29-32, wherein applying the flame-retardant treatment composition to the substrate comprises immersing the substrate in the flame-retardant treatment composition for a duration of 1 min to 1 hour.

Aspect 34 provides the method of any one of Aspects 29-33, wherein the light comprises a wavelength of 360 nm to 370 nm.

Aspect 35 provides the method of any one of Aspects 29-34, wherein the light treatment comprises exposing the composition on the substrate to the light for a duration of 0.1 min to 1 hour.

Aspect 36 provides the method of any one of Aspects 29-35, wherein the light treatment comprises exposing the composition on the substrate to the light for a duration of 1 min to 20 min.

Aspect 37 provides the method of any one of Aspects 29-36, further comprising drying the substrate comprising the cured composition.

Aspect 38 provides the method of any one of Aspects 29-37, wherein the substrate is a porous substrate.

Aspect 39 provides the method of any one of Aspects 29-38, wherein the substrate comprises a fiber, natural wood, plywood, or oriented strand board (OSB).

Aspect 40 provides a flame-retardant coating comprising a photopolymerized product of the flame-retardant treatment composition of any one of Aspects 1-26.

Aspect 41 provides the flame-retardant coating of Aspect 40, wherein the photopolymerized product of the flame-retardant treatment composition is a photopolymerized and dried product of the flame-retardant treatment composition.

Aspect 42 provides the flame-retardant coating of any one of Aspects 40-41, wherein the photopolymerized product of the flame-retardant treatment composition comprises a polyelectrolyte complex of the polyamine and a polymer formed from the phosphoric acid methacrylate ester.

Aspect 43 provides the flame-retardant coating of any one of Aspects 40-42, wherein the photopolymerized product of the flame-retardant treatment composition comprises a poly(HMP):polyamine polyelectrolyte complex.

Aspect 44 provides a flame-retardant coating comprising a polyelectrolyte complex of polyamine and a poly(phosphoric acid methacrylate ester).

Aspect 45 provides the flame-retardant coating of Aspect 44, wherein the polyelectrolyte complex is a product of photopolymerization of a flame-retardant treatment composition comprising a polyamine, a phosphoric acid methacrylate ester, and a photoinitiator.

Aspect 46 provides the flame-retardant coating of any one of Aspects 44-45, wherein a weight ratio of the polyamine to the poly(phosphoric acid methacrylate ester) is 1:1 to 1:10.

Aspect 47 provides the flame-retardant coating of any one of Aspects 44-46, wherein a weight ratio of the polyamine to the poly(phosphoric acid methacrylate ester) is 1:2 to 1:4.

Aspect 48 provides a flame-retardant substrate comprising:
a porous substrate; and
the flame-retardant coating of any one of Aspects 38-47 on the porous substrate.

Aspect 49 provides the flame-retardant substrate of Aspect 48, wherein 0.1 wt % to 50 wt % of the flame-retardant substrate is the flame-retardant coating.

Aspect 50 provides the flame-retardant substrate of any one of Aspects 48-49, wherein 1 wt % to 30 wt % of the flame-retardant substrate is the flame-retardant coating.

Aspect 51 provides the flame-retardant substrate of any one of Aspects 48-50, wherein the flame-retardant coating is penetrated into pores of the substrate.

Aspect 52 provides the flame-retardant substrate of any one of Aspects 48-51, wherein the porous substrate is a fiber, natural wood, plywood, or oriented strand board (OSB).

Aspect 53 provides the flame-retardant substrate of any one of Aspects 48-52, wherein the porous substrate is wood.

Aspect 54 provides the flame-retardant substrate of Aspect 53, wherein the flame-retardant coating is penetrated into pores of the wood to a depth of 1-20 mm.

Aspect 55 provides the flame-retardant substrate of any one of Aspects 53-54, wherein the flame-retardant coating is penetrated into pores of the wood to a depth of 2-10 mm.

Aspect 56 provides the flame-retardant substrate of any one of Aspects 53-55, wherein the flame-retardant coating is penetrated through an entire thickness of the wood.

Aspect 57 provides the flame-retardant substrate of any one of Aspects 53-56, wherein as compared to a corresponding untreated substrate, the flame-retardant substrate has a reduction in afterburn time of 50% to 99.9% in a flame test comprising applying a flame 1 cm below the substrate for 10 s, removing the flame until flaming combustion stops, and then applying the flame 1 cm below the substrate for an additional 10 s.

Aspect 58 provides the flame-retardant substrate of any one of Aspects 53-57, wherein as compared to a corresponding untreated substrate, the flame-retardant substrate has a reduction in afterburn time of 73% to 98% in a flame test comprising applying a flame 1 cm below the substrate for 10 s, removing the flame until flaming combustion stops, and then applying the flame 1 cm below the substrate for an additional 10 s.

Aspect 59 provides the flame-retardant substrate of any one of Aspects 53-58, wherein as compared to a corresponding untreated substrate, the flame-retardant substrate has a decrease in maximum average rate of heat emission in cone calorimetry testing as per ASTM E-1354-22 of 10% to 6⁰%.

Aspect 60 provides the flame-retardant substrate of any one of Aspects 53-59, wherein as compared to a corresponding untreated substrate, the flame-retardant substrate has a decrease in maximum average rate of heat emission in cone calorimetry testing as per ASTM E-1354-22 of 25% to 40%.

Aspect 61 provides a flame-retardant substrate comprising:
a substrate comprising wood; and
a flame-retardant coating on the wood, the flame-retardant coating comprising a polyelectrolyte complex of a polyamine and a poly(phosphoric acid methacrylate ester), wherein a weight ratio of the polyamine to the poly(phosphoric acid methacrylate ester) is 1:1 to 1:10 and 1 wt % to 30 wt % of the flame-retardant substrate is the flame-retardant coating.

Aspect 62 provides the composition, coating, substrate, or method of any one or any combination of Aspects 1-61 optionally configured such that all elements or options recited are available to use or select from.

What is claimed is:

1. A flame-retardant treatment composition comprising:
a polyamine;
a phosphoric acid methacrylate ester; and
a photoinitiator.

2. The flame-retardant treatment composition of claim 1, wherein the polyamine is 10 wt % to 40 wt % of the composition on a dry weight basis, wherein the polyamine has a weight-average molecular weight of 100 g/mol to 1,000,000 g/mol, and wherein the polyamine comprises polyethylenimine (PEI), poly(allylamine), poly(vinylamine), chitosan, a salt thereof, or a combination thereof.

3. The flame-retardant treatment composition of claim 1, wherein the phosphoric acid methacrylate ester is 50 wt % to 90 wt % of the composition on a dry weight basis, wherein the phosphoric acid methacrylate ester comprises phosphoric acid 2-hydroxyethyl methacrylate ester (HMP), bis[2-(methacryloyloxy)ethyl]phosphate, or a combination thereof.

4. The flame-retardant treatment composition of claim 1, wherein the phosphoric acid methacrylate ester is phosphoric acid 2-hydroxyethyl methacrylate ester (HMP).

5. The flame-retardant treatment composition of claim 1, wherein a weight ratio of the polyamine to the phosphoric acid methacrylate ester is 1:1 to 1:10.

6. The flame-retardant treatment composition of claim 1, wherein the photoinitiator is 0.1 wt % to 10 wt % of the composition on a dry weight basis.

7. The flame-retardant treatment composition of claim 1, wherein the photoinitiator is diphenyl(2,4,6 trimethylbenzoyl)phosphine oxide (TPO), phenylbis(2,4,6-trimethylbenzoyl)phosphine oxide, 2-hydroxy-2-methylpropiophenone, 2-hydroxy-4′-(2-hydroxyethoxy)-2-methylpropiophenone, lithium phenyl-2,4,6-trimethylbenzoylphosphinate (Li-TPO), ethyl phenyl(2,4,6-trimethylbenzoyl)phosphinate (TPO-L), camphorquinone, or a combination thereof.

8. The flame-retardant treatment composition of claim 1, further comprising a solvent, wherein the composition has a pH of 5 to 8.

9. A method of applying a flame-retardant treatment composition comprising:
applying the flame-retardant treatment composition to a substrate; and
curing the composition on the substrate comprising exposing the composition on the substrate to light.

10. The method of claim 9, wherein applying the flame-retardant treatment composition to the substrate comprises immersing the substrate in the flame-retardant treatment composition for a duration of 1 sec to 48 hours, wherein the light treatment comprises exposing the composition on the substrate to the light for a duration of 0.1 min to 1 hour.

11. The method of claim 9, further comprising drying the substrate comprising the cured composition.

12. The method of claim 9, wherein the substrate comprises wood or a fiber.

13. A flame-retardant coating comprising a photopolymerized product of the flame-retardant treatment composition of claim 1.

14. A flame-retardant coating comprising a polyelectrolyte complex of a polyamine and a poly(phosphoric acid methacrylate ester).

15. A flame-retardant substrate comprising:
a porous substrate; and
the flame-retardant coating of claim 13 on the porous substrate.

16. The flame-retardant substrate of claim 15, wherein 0.1 wt % to 50 wt % of the flame-retardant substrate is the flame-retardant coating.

17. The flame-retardant substrate of claim 15, wherein the flame-retardant coating is penetrated into pores of the substrate.

18. The flame-retardant substrate of claim 15, wherein the porous substrate comprises a fiber or wood.

19. The flame-retardant substrate of claim 18, wherein the porous substrate comprises wood, wherein
as compared to a corresponding untreated substrate, the flame-retardant substrate has a reduction in afterburn time of 50% to 99.9% in a flame test comprising applying a flame 1 cm below the substrate for 10 s, removing the flame until flaming combustion stops, and then applying the flame 1 cm below the substrate for an additional 10 s; and/or
as compared to a corresponding untreated substrate, the flame-retardant substrate has a decrease in maximum average rate of heat emission in cone calorimetry testing as per ASTM E-1354-22 of 10% to 6⁰%.

20. A flame-retardant substrate comprising:
a substrate comprising wood; and
a flame-retardant coating on the wood, the flame-retardant coating comprising a polyelectrolyte complex of a polyamine and a poly(phosphoric acid methacrylate ester), wherein a weight ratio of the polyamine to the poly(phosphoric acid methacrylate ester) is 1:1 to 1:10 and 1 wt % to 30 wt % of the flame-retardant substrate is the flame-retardant coating.
